(19) United States
(12) Patent Application Publication
(10) Pub. No.: US 2006/0288309 A1
(43) Pub. Date: Dec. 21, 2006

(54) Displaying available menu choices in a multimodal browser

(76) Inventors: Charles W. Cross JR., Wellington, FL (US); Michael C. Hollinger, Memphis, TN (US); Igor R. Jablokov, Charlotte, NC (US); Benjamin D. Lewis, Ann Arbor, MI (US); Hilary A. Pike, Austin, TX (US); Daniel M. Smith, Raleigh, NC (US); David W. Wintermute, Boynton Beach, FL (US); Michael A. Zaitzeff, Carson City, NV (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/154,899

(22) Filed: Jun. 16, 2005

(51) Int. Cl. G06F 17/00

(52) U.S. Cl. 715/825

(57) ABSTRACT

Methods, systems, and products are disclosed for displaying available menu choices in a multimodal browser including presenting a user a plurality of GUI menu fields; selecting one of the plurality of GUI menu fields; and displaying, in a GUI display box for the plurality of GUI menu fields, menu choices for the selected GUI menu field.

### BACKGROUND OF THE INVENTION

1. Field of the Invention

The field of the invention is data processing, or, more specifically, methods, systems, and products for displaying available menu choices in a multimodal browser.

2. Description of Related Art

User interaction with applications running on small devices through a keyboard or stylus has become increasingly limited and cumbersome as those devices have become increasingly smaller. In particular, small handheld devices like mobile phones and PDAs serve many functions and contain sufficient processing power to support user interaction through other modes, such as multimodal access. Devices which support multimodal access combine multiple user input modes or channels in the same interaction allowing a user to interact with the applications on the device simultaneously through multiple input modes or channels. The methods of input include speech recognition, keyboard, touch screen, stylus, mouse, handwriting, and others. Multimodal input often makes using a small device easier.

Displaying many menu choices for many fields on small multimodal devices is difficult due to size constraints of typical GUI (“Graphical User Interface”). When a plurality of menu fields are presented to a user, having a display box for each field to present the menu choices to the user requires too much display space in the GUI display. There is therefore an ongoing need for improvement in displaying available menu choices in a multimodal browser.

### SUMMARY OF THE INVENTION

Methods, systems, and products are disclosed for displaying available menu choices in a multimodal browser. Embodiments include presenting a user a plurality of GUI menu fields; receiving user speech; selecting one of the plurality of GUI menu fields in dependence upon the user speech and field selection rules; and displaying, in a GUI display box for the plurality of GUI menu fields, menu choices for the selected GUI menu field. Typical embodiments also include highlighting the selected GUI menu field and displaying to the user an icon representing selection attribute of at least one of the plurality of GUI menu fields.

Receiving user speech may include receiving a user instruction to select a particular GUI menu field. Receiving user speech may also include receiving a selection of a menu choice from a user; and selecting one of the plurality of GUI menu fields in dependence upon user speech and field selection rules may include determining whether the selection matches one of a plurality of menu choices associated with the plurality of GUI menu fields, identifying a GUI menu field associated with the selection if the selection matches one of the menu choices, and identifying at least one GUI menu field not associated the matching menu choice.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system of devices each of which is capable of supporting a multimodal browse.

FIG. 2 sets forth a block diagram of a multimodal framework useful in implementing embodiments of the present invention.

FIG. 3 sets forth a block diagram of automated computing machinery comprising an exemplary computer capable of supporting a multimodal browser.

FIG. 4 sets forth a flow chart illustrating an exemplary method for displaying available menu choices in a multimodal browser.

FIG. 5 sets forth a line drawing of an exemplary multimodal browser operating in accordance with the method of FIG. 4.

FIG. 6 sets forth a flow chart illustrating an example of selecting a GUI menu field in dependence upon field selection rules.

FIG. 7 sets forth a line drawing of an exemplary multimodal browser+operating in accordance with the method of FIG. 6.

### DETAILED DESCRIPTION OF EXEMPLARY EMBODIMENTS

### Introduction

The present invention is described to a large extent in this specification in terms of methods for displaying available menu choices in a multimodal browser. Persons skilled in the art, however, will recognize that any computer system that includes suitable programming means for operating in accordance with the disclosed methods also falls well within the scope of the present invention. Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit.

The invention also may be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executed on computer hardware, nevertheless, alternative embodiments implemented as firmware or as hardware are well within the scope of the present invention.

### Displaying Available Menu Choices in a Multimodal Browser

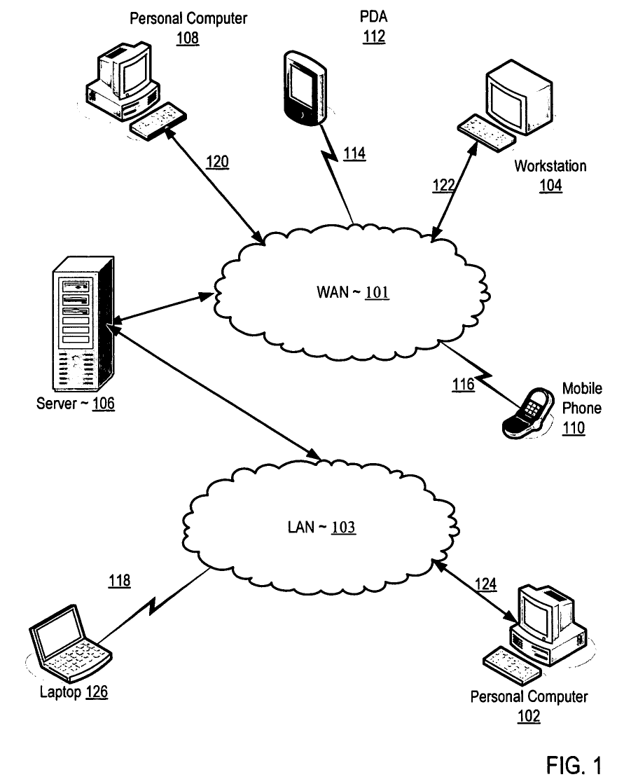

Exemplary methods, systems, and products for displaying available menu choices in a multimodal browser according to embodiments of the present invention are described with reference to the accompanying drawings, beginning with FIG. 1. FIG. 1 sets forth a network diagram illustrating an exemplary system of devices including a plurality of client devices capable of supporting a multimodal browser according to embodiments of the present invention and a server capable of serving up multimodal web pages according to embodiments of the present invention.

The data processing system of FIG. 1 includes wide area network (“WAN”) (101) and local area network (“LAN”) (103). The network connection aspect of the architecture of FIG. 1 is only for explanation, not for limitation. In fact, systems for displaying available menu choices in multimodal browsers according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, server (106) implements a gateway, router, or bridge between LAN (103) and WAN (101). Server (106) may be any computer capable of accepting a request for a multimodal web pages and responding by providing the multimodal web page to a requesting client device. One example of such a server is an HTTP (‘HyperText Transport Protocol’) server or ‘web server.’ The exemplary server (106) is capable supporting a multimodal web application capable of serving up multimodal web pages according to embodiments of the present invention. Such applications create multimodal web pages that display available menu choices by presenting a user a plurality of GUI menu fields; receiving user speech; selecting one of the plurality of GUI menu fields in dependence upon user speech and field selection rules; and crating web pages that display, in a GUI display box for the plurality of GUI menu fields, menu choices for the selected GUI menu field.

The system of FIG. 1 includes a plurality of exemplary client devices (108, 112, 104, 110, 126, and 102) each of which is capable of supporting a multimodal browser according to the present invention. Such multimodal browsers are capable generally of displaying multimodal web pages that present a user a plurality of (‘Graphical User Interface’) GUI menu fields. Such multimodal browsers are also capable or receiving user speech used to select one of the plurality of GUI menu fields and displaying web pages that display, in a GUI display box for the plurality of GUI menu fields, menu choices for the selected GUI menu field.

A ‘multimodal browser’ is typically a web browser capable of receiving multimodal input and interacting with users with multimodal output. Multimodal browsers typically render web pages written in XHTML+Voice (X+V). X+V provides a markup language that enables users to interact with application through spoken dialog in addition to traditional means of input such as keyboard strokes and mouse pointer action. X+V adds spoken interaction to web content by integrating the XHTML (extensible Hypertext Markup Language) and speech recognition vocabularies. XHTML includes voice modules that support speech synthesis, speech dialogs, command and control, and speech grammars. Voice handlers can be attached to XHTML elements and respond to specific events. Voice interaction features are integrated with XHTML and can consequently be used directly within XHTML content.

In the example of FIG. 1, several exemplary client devices including a PDA (112), a computer workstation (104), a mobile phone (110), and a personal computer (108) are connected to WAN (101). Network-enabled mobile phone (110) connects to the WAN (101) through a wireless link (116), and the PDA (112) connects to the network (101) through a wireless link (114). In the example of FIG. 1, the personal computer (108) connects through a wireline connection (120) to the WAN (101) and the computer workstation (104) connects through a wireline connection (122) to the WAN (101). In the example of FIG. 1, the laptop (126) connects through a wireless link (118) to the LAN (103) and the personal computer (102) connects through a wireline connection (124) to LAN (103).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms in addition to those illustrated in FIG. 1.

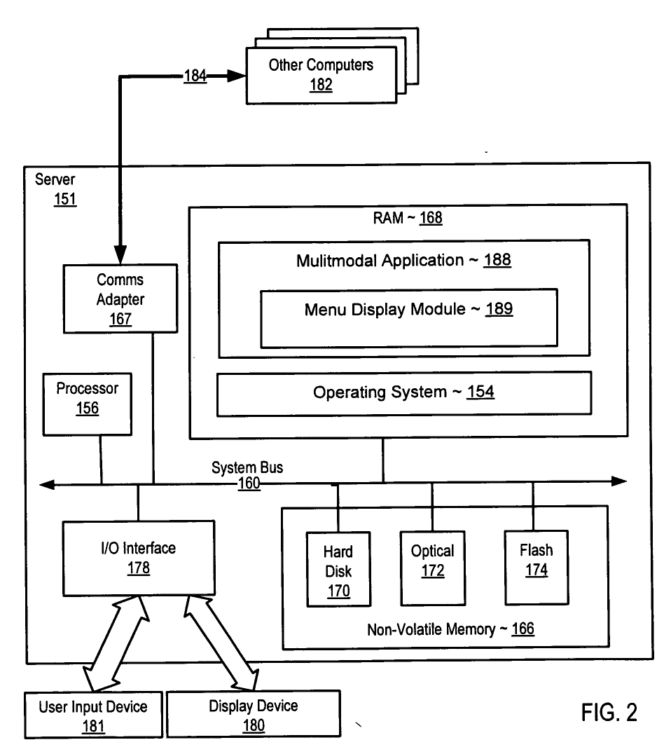

Multimodal applications for displaying available menu choices in a multimodal browser in accordance with the present invention are generally implemented with computers, that is, with automated computing machinery. For further explanation, therefore, FIG. 2 sets forth a block diagram of automated computing machinery comprising an exemplary server (151) capable of supporting a multimodal application (188) having a menu display module (189) according to embodiments of the present invention.

The server (151) of FIG. 2 includes at least one computer processor (156) or ‘CPU ’ as well as random access memory (168) (“RAM”) which is connected through a system bus (160) to processor (156) and to other components of the computer. Stored in RAM (168) is an operating system (154). Operating systems useful in computers according to embodiments of the present invention include UNIX™, Linux™, Microsoft NT™, AIX™, IBM's i5os, and many others as will occur to those of skill in the art.

Also stored in RAM (168) is a multimodal application (188) having a menu display module (189) according to embodiments of the present invention. The menu display module (189) comprises computer program instructions. The menu display module creates web pages that present a user a plurality of GUI menu fields. The menu display module is also capable of selecting one of the plurality of GUI menu fields, often in response to a user speech and in dependence upon field selection rules, and creating web pages that display, in a GUI display box for the plurality of GUI menu fields, menu choices for the selected GUI menu field.

Server (151) of FIG. 2 includes non-volatile computer memory (166) coupled through a system bus (160) to processor (156) and to other components of the server (151). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary server (151) of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary server (151) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in multimodal applications according to embodiments of the present invention include modems for wired dial-up communications, Ethernet (IEEE 802.3) adapters for wired network communications, and 802.11b adapters for wireless network communications.

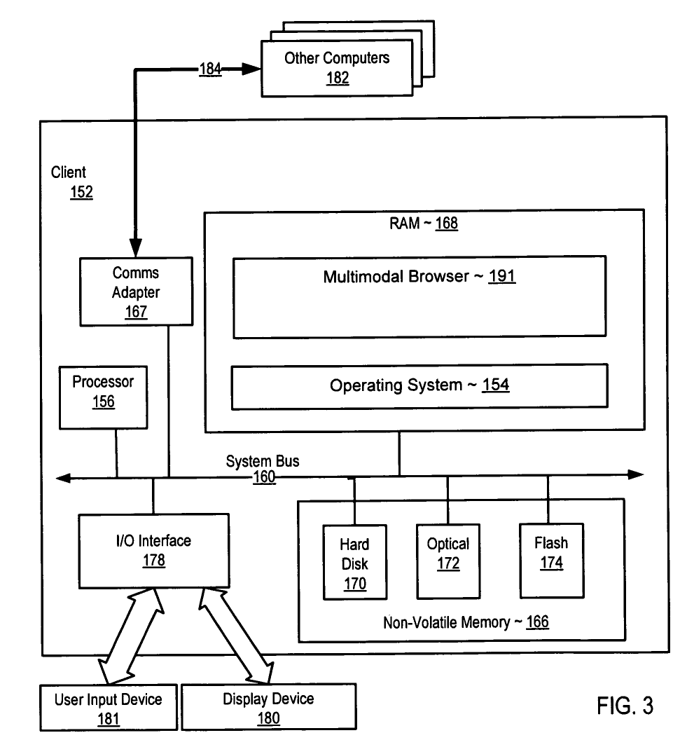

Multimodal browsers display multimodal web pages according to embodiments of the present invention. For further explanation, therefore, FIG. 3 sets forth a block diagram of automated computing machinery comprising an exemplary client (152) capable of supporting a multimodal browser capable of presenting a user a plurality of GUI menu fields, receiving a user instruction to select one of the plurality of GUI menu fields; and displaying, in a GUI display box for the plurality of GUI menu fields, menu choices for the selected GUI menu field. The client (152) of FIG. 3 includes at least one computer processor (156) or ‘CPU’ as well as random access memory (168) (“RAM”) which is connected through a system bus (160) to processor (156) and to other components of the computer. Stored in RAM (168) is an operating system (154). Operating systems useful in computers according to embodiments of the present invention include UNIX™, Linux™, Microsoft NT™, AIX™, IBM's i5os, and many others as will occur to those of skill in the art.

Also stored in RAM (168) is a multimodal browser (191). The multimodal browser (191) of FIG. 2 displays available menu choices by presenting a user a plurality of GUI menu fields; receiving a user speech useful in selecting one of the plurality of GUI menu fields; and displaying, in a GUI display box for the plurality of GUI menu fields, menu choices for the selected GUI menu field.

Client (152) of FIG. 3 includes non-volatile computer memory (166) coupled through a system bus (160) to processor (156) and to other components of the client (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The exemplary client of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary client (152) of FIG. 3 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful in multimodal applications according to embodiments of the present invention include modems for wired dial-up communications, Ethernet (IEEE 802.3) adapters for wired network communications, and 802.11b adapters for wireless network communications.

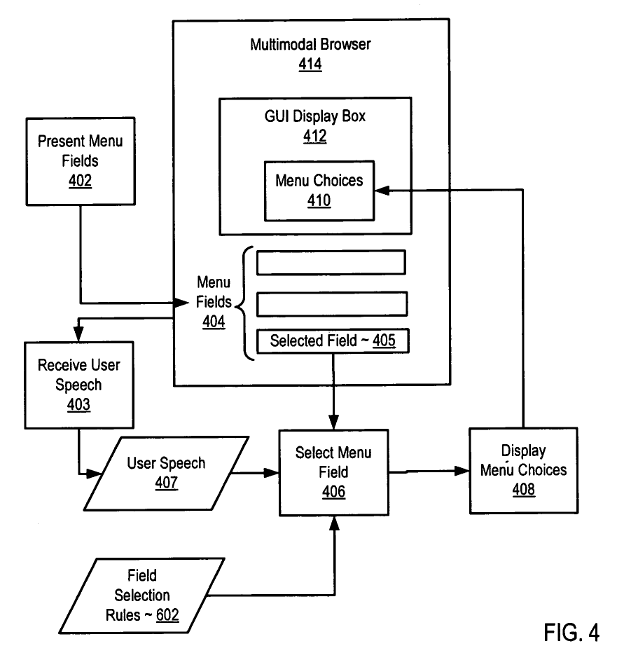

For further explanation, FIG. 4 sets forth a flow chart illustrating an exemplary method for displaying available menu choices in a multimodal browser (414). The method of FIG. 4 includes presenting (402) a user a plurality of GUI menu fields (404). Presenting (402) a user a plurality of GUI menu fields (404) may be carried out by presenting text in a GUI text box describing to the user the menu field to be filled, displaying an icon representing the GUI menu field or any other way of presenting a user a GUI menu field that will occur to those of skill in the art. Examples of text describing the menu field include ‘Select a city,’ ‘Select a time,’ ‘Select a zip code,’ and so on as will occur to those of skill in the art.

In the example of FIG. 4, each of the plurality of GUI menu fields (404) has an associated set of menu choices for display in the GUI display box (412). The GUI display box in the example of FIG. 4 is a single GUI display box for displaying the menu choices of each of the plurality of GUI menu fields (404). The GUI display box (412) displays the menu choices of the currently selected menu field. A selected GUI menu field is often said to be ‘in focus.’ When the menu field is selected, or in focus, the menu choices associated with that GUI menu field are displayed in the GUI display box and a user is empowered to select a menu choice to fill the menu field.

The method of FIG. 4 also includes receiving (403) user speech (407) and selecting (406) one (405) of the plurality of GUI menu fields (404) in dependence upon the user speech (407) and field selection rules (602). Field selection rules are rules that govern parsing of user speech that are designed to facilitate selecting one of the GUI menu fields in response to receiving the user speech. In one straightforward example, receiving (403) user speech (407) and selecting (406) one (405) of the plurality of GUI menu fields (404) in dependence upon the user speech (407) and field selection rules (602) may be carried out by receiving a speech instruction identifying one of the available menu fields and selecting the menu field in dependence upon a rule that states that when user speech identifies a menu field select the identified menu field.

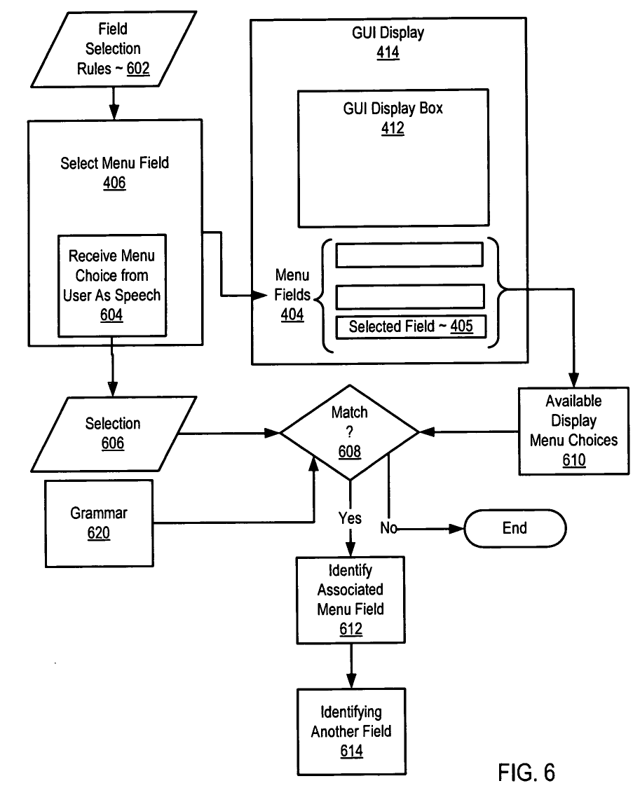

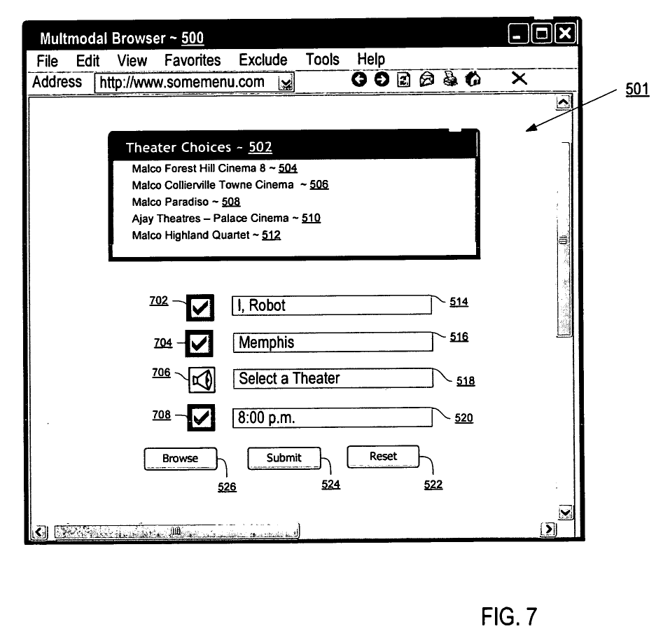

As discussed above, multimodal applications are capable of receiving user instructions as speech as well as traditional forms of input such as a keyboard instruction, a mouse click or any other way of receiving a user instruction that will occur to those of skill in the art. Field selection rules may also be used to determine or infer a user selection of a GUI menu field in the absence of a direct user instruction identified as a specific selection, such as by dictating how a speech instruction in conjunction with a keystroke are to be interpreted for selecting one of the GUI menu fields. An additional example of the selection of a GUI menu in dependence upon such field selection rules is described in more detail below with reference to FIGS. 6 and 7.

The method of FIG. 4 includes displaying (408), in a GUI display box (412) for the plurality of GUI menu fields (404), menu choices (410) for the selected GUI menu field (405). As described above, the GUI display box (412) of FIG. 4 is a single box available to display the menu choices associated with any of the GUI menu fields (404) and upon selection of the selected field (405), a multimodal browser operating in accordance with the present invention displays the menu choices (410) in the GUI display box (412).

Multimodal web pages displayed in multimodal browsers according to the method of FIG. 4 often notify the user of the section of the GUI menu field through highlighting a selected GUI menu field. Highlighting the selected GUI menu field may be carried out by through the use of a GUI display icon demonstrating that the GUI menu field has been selected, text in a GUI menu field in a predetermined font, or any other way of highlighting the GUI menu field that will occur to those of skill in the art.

Multimodal web pages displayed in multimodal browsers according to the method of FIG. 4 may also provide to the user an indication of selection attributes for GUI menu fields by displaying to the user a GUI icon representing selection attributes of a GUI menu field. Selection attributes are additional information concerning the status of the GUI menu field or selection requirements of the GUI menu field. Examples of such selection attributes are ‘required’ indicating to a user that the selection of a menu choice for the GUI menu field is required, ‘optional’ indicating to a user that the selection of a menu choice for the GUI menu field is not required, ‘listening’ indicating to a user that the GUI menu field is currently selected and accepting menu choices from the user, ‘filled’ indicating to a user that a GUI menu field has accepted a menu choice, and so on as will occur to those of skill in the art.

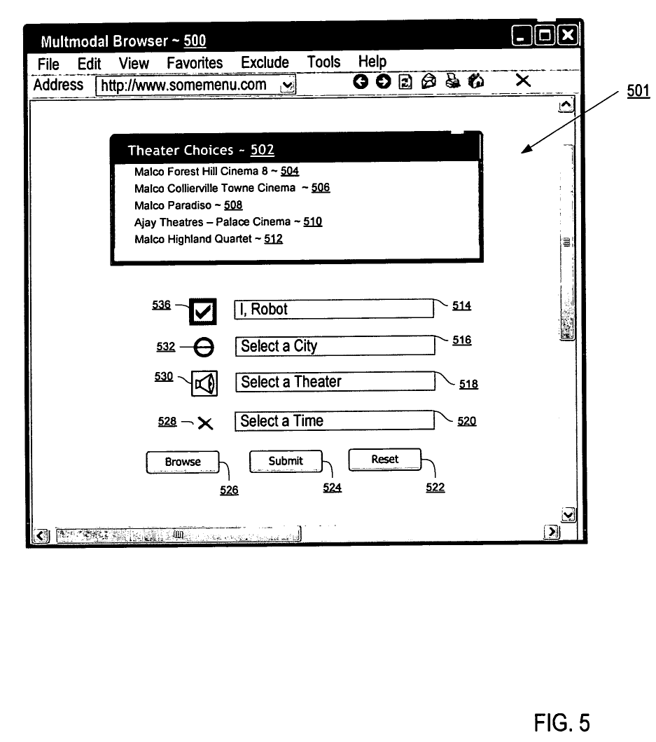

For further explanation, FIG. 5 sets forth a line drawing of an exemplary multimodal browser (500) operating in accordance with the method of FIG. 4. The exemplary multimodal browser (500) in the example of FIG. 5 is displaying a multimodal web page (501) for the selection of a movie being shown in a particular theater in a particular city at a particular time. The web page (501) of FIG. 5 has four GUI menu fields (514, 516, 518, and 520) and a GUI display box (502) for displaying menu choices (504, 506, 508, 510, and 512) for the selected GUI menu field (518). The web page (501) of FIG. 5 also includes a plurality of icons (536, 532, 530, and 528) that represent selection attributes of the GUI menu fields (514, 516, 518, and 520).

In the example of FIG. 5, the first GUI menu field (514) accepts a user selection of movies and in this example a user has selected the movie ‘I, Robot.’ As a result of the user having selected the movie I, Robot, text describing the user's selection appears in the GUI menu field (514). As a result of the user's selection, an icon (536) representing the selection attribute ‘filled’ is displayed next to the GUI menu field (514) indicating to the user that a menu choice for the GUI menu field has been selected.

The second GUI menu field (516) in the example of FIG. 5 accepts a user selection of a city. In the example of FIG. 5, no city is currently selected and therefore the GUI menu field (516) includes text prompting the user to select a city. Furthermore, the second GUI menu field (516) is not required and therefore an icon (532) representing the selection attribute ‘optional’ is displayed next to the GUI menu field (516).

The third GUI menu field (518) in the example of FIG. 5 accepts a user selection of a theater. In the example of FIG. 5, the third GUI menu field (518) is currently selected and accepting menu choices from a user. As a result of the selection of the GUI menu field, an icon (530) representing the selection attribute ‘listening’ is displayed next to the GUI menu field (518). Also as a result of the selection of the GUI menu field, theater choices are displayed in the GUI display box (502). In the example of FIG. 5, five menu choices are displayed in the GUI display box (502). The menu choices include ‘Malco Forest Hill Cinema 8’ (504), ‘Malco Collierville Towne Cinema’ (506), ‘Malco Paridiso’ (508), ‘Ajay Theatres-Palace Cinema’ (510), and ‘Malco Highland Quartet’ (512). A user of the example of FIG. 5 is advantageously informed of the menu choices and prompted to select one of the menu choices with the text ‘Select a Theater’ displayed in the GUI menu field (518).

The fourth GUI menu field (520) in the example of FIG. 5 accepts a user selection of a movie time. In the example of FIG. 5, no movie is currently selected and therefore the GUI menu field (520) includes the text ‘Select a Time’ prompting the user to select a movie time. Furthermore, the fourth GUI menu field (520) is required and not filled and therefore an icon (528) representing the selection attribute ‘required, not filled’ is displayed next to the GUI menu field (520). The exemplary multimodal web page of FIG. 5 is presented for explanation and not for limitation. In fact, displaying available menu choices in a multimodal browser by presenting a user a plurality of GUI menu fields, selecting one of the plurality of GUI menu fields, and displaying, in a GUI display box for the plurality of GUI menu fields, menu choices for the selected GUI menu field may occur in many forms and all such forms are within the scope of the present invention.

As discussed above, multimodal applications often receive in the same user interaction more than one instruction. For example, a user saying “I would like to see Spiderman at eight o'clock” may in fact select in a single utterance two of the required menu fields of the example of FIG. 5. Such an interaction with a user is often called ‘mixed initiative’ dialog. For further explanation, therefore, FIG. 6 sets forth a flow chart illustrating an example of selecting a GUI menu field in dependence upon field selection rules that provide mixed initiative dialog with a user. In the example of FIG. 6, the GUI menu field is selected in dependence upon field selection rules (602). Field selection rules are rules that govern parsing of a user instruction. Such rules often operate by determining whether a user has in fact selected menu choices, and determining if other required menu choices remain for user selection.

The example of FIG. 6 sets forth a flow chart illustrating one way of selecting (406) a GUI menu field in dependence upon field selection rules (602) that includes receiving (604), as speech, a selection (606) of a menu choice from a user. In some examples of FIG. 6 additional input such as handwritten selections, keyboard selections or any other selection as will occur to those of skill in the art may also be used in addition to the speech selection and the field selection rules may also include such multimodal input in selecting a particular menu field.

The method of FIG. 6 also includes determining (608) whether the selection (606) matches one of a plurality of menu choices (610) associated with the plurality of GUI menu fields (404). In the example of FIG. 6 the selection (606) is received as a speech instruction and therefore determining (608) whether the selection (606) matches one of a plurality of menu choices (610) includes parsing the speech instruction against a grammar (620) and comparing the parsed speech instruction to the menu choices associated with GUI menu fields. Determining (608) whether the selection (606) matches one of a plurality of menu choices (610) may be carried out by a web application running on a server coupled for data communications with the multimodal web browser.

The method of FIG. 6 includes identifying (612) a menu field associated with the selection if the selection matches one of the menu choices (610) and identifying (614) at least one GUI menu field not associated the matching menu choice. Identifying (612) a menu field associated with the selection if the selection matches one of the menu choices (610) results in identifying a GUI menu field that is filled by the user's selection and therefore does not remain for selection according to the method of FIG. 6. Identifying (614) at least one GUI menu field not associated the matching menu choice therefore results in identifying a GUI menu field that remains for selection and remains unfilled by the user. Identifying (612) a menu field associated with the selection if the selection matches one of the menu choices (610) and identifying (614) at least one GUI menu field not associated the matching menu choice may be carried out by a web application running on a server coupled for data communication with the multimodal browser.

In the method of FIG. 6, if the user selection (606) does not match one of a plurality of menu choices (610) associated with the plurality of GUI menu fields (404) then the selection does not provide enough information to select a GUI menu field according to the method of FIG. 6. The method of FIG. 6 advantageously provides a vehicle for selecting a GUI menu field in dependence upon field selection rules that provides mixed initiative dialog with a user.

Furthermore, having selected a GUI menu field according to the method of FIG. 6, embodiments may include prompting a user to select a menu choice of the selected one of the GUI menu fields not associated the matching menu choice. That is, embodiments may include prompting the user to select a menu choice of menu field selected by the method of FIG. 6. Prompting a user to select a menu choice may be carried out by displaying the menu choices and displaying an icon notifying a user that the multimodal application is listening for a user selection of one of the menu choices, or any other way of prompting a user that will occur to those of skill in the art.

For further explanation, FIG. 7 sets forth a line drawing of an exemplary multimodal browser (500) operating in accordance with the method of FIG. 6. The exemplary multimodal browser (500) in the example of FIG. 7 is displaying a multimodal web page (501) for the selection of a movie being shown in a particular theater in a particular city at a particular time. The web page (501) of FIG. 7 has four GUI menu fields (514, 516, 518, and 520) and a GUI display box (502) for displaying menu choices (504, 506, 508, 510, and 512) for the selected GUI menu field (518). The web page (501) of FIG. 7 also includes a plurality of icons (702, 704, 706, and 708) that representing a selection attributes of the GUI menu fields (514, 516, 518, and 520).

FIG. 7 illustrates an example of selecting the GUI menu field in dependence upon field selection rules by receiving a selection of a menu choice from a user, determining whether the selection matches one of a plurality of menu choices associated with the plurality of GUI menu fields, identifying a menu field associated with the selection if the selection matches one of the menu choices, and identifying at least one GUI menu field not associated with the identified menu field associated with the matching menu choice.

In the example of FIG. 7 the multimodal browser (500) displaying the multimodal web page (501) receives a user selection in the form of the following speech utterance, “I want to see I, Robot in Memphis at 8 o'clock at night.” In the example of FIG. 7, a web application coupled fro data communications with the browser (500) of FIG. 7 parses the speech utterance against a grammar and compares the parsed utterance with the menu choices associated with the GUI menu fields (514, 516, 518, and 520).

In the example of FIG. 7, the first GUI menu field (514) had a matching associated menu choice for the movie ‘I, Robot.’ As a result, the web application serves up a web page for display in the browser (500) that displays text describing the user's selection in the GUI menu field (514) and an icon (702) representing the selection attribute ‘filled’ next to the GUI menu field (514) indicating to the user that a menu choice for the GUI menu field has been selected.

In the example of FIG. 7, the second GUI menu field (516) had a matching associated menu choice for the city of ‘Memphis’. As a result, the web page displayed in the browser (500) displays text describing the user's selection ‘Memphis’ in the GUI menu field (516) and an icon (704) representing the selection attribute ‘filled’ next to the GUI menu field (516) indicating to the user that a menu choice for the GUI menu field has been selected.

In the example of FIG. 7, the fourth GUI menu field (520) had a matching associated menu choice for the time of ‘8:00 p.m.’ As a result, the web page displayed in the browser (500) displays text describing the user's selection ‘8:00 p.m.’ in the GUI menu field (520) and an icon (708) representing the selection attribute ‘filled’ next to the GUI menu field (520) indicating to the user that a menu choice for the GUI menu field has been selected.

In the example of FIG. 7, the web application coupled for data communications with the browser (500) identifies the remaining GUI menu field (518) not associated with the other identified menu fields (514, 516, and 520) that are associated with the matching menu choices. The third GUI menu field (518) in the example of FIG. 7 is selected and therefore is currently accepting from a user menu choices. As a result of the selection of the GUI menu field, an icon (706) representing the selection attribute ‘listening’ is displayed next to the GUI menu field (518) in the web page displayed in the browser. Also as a result of the selection of the GUI menu field, theater choices are displayed in the GUI display box (502). In the example of FIG. 7, five menu choices are displayed in the GUI display box (502). The menu choices include ‘Malco Forest Hill Cinema 8’ (504), ‘Malco Collierville Towne Cinema’ (506), ‘Malco Paridiso’ (508), ‘Ajay Theatres—Palace Cinema’ (510), and ‘Malco Highland Quartet’ (512). A user of the example of FIG. 7 is advantageously informed of the menu choices and prompted to select one of the menu choices with the text ‘Select a Theater’ displayed in the GUI menu field (518).

The exemplary multimodal web page of FIG. 7 is presented for explanation and not for limitation. In fact, displaying available menu choices in a multimodal browser by presenting a user a plurality of GUI menu fields, selecting one of the plurality of GUI menu fields in dependence upon field selection rules, and displaying, in a GUI display box for the plurality of GUI menu fields, menu choices for the selected GUI menu field may occur in many forms and all such forms are within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for displaying available menu choices in a multimodal browser, the method comprising:
presenting a user a plurality of GUI menu fields;
receiving user speech;
selecting one of the plurality of GUI menu fields in dependence upon the user speech and field selection rules; and
displaying, in a GUI display box for the plurality of GUI menu fields, menu choices for the selected GUI menu field.

2. The method of claim 1 wherein receiving user speech further comprises receiving a user instruction to select a particular GUI menu field.

3. The method of claim 3 wherein receiving user speech further comprises receiving a selection of a menu choice from a user; and
selecting one of the plurality of GUI menu fields in dependence upon user speech and field selection rules further comprises determining whether the selection matches one of a plurality of menu choices associated with the plurality of GUI menu fields;
identifying a GUI menu field associated with the selection if the selection matches one of the menu choices; and
identifying at least one GUI menu field not associated the matching menu choice.

4. The method of claim 3 further comprising prompting a user to select a menu choice of at least one of the GUI menu field not associated the matching menu choice.

5. The method of claim 1 further comprising highlighting the selected GUI menu field.

6. The method of claim 1 further comprising displaying to the user an icon representing a selection attribute of at least one of the plurality of GUI menu fields.

7. A system for displaying available menu choices in a multimodal browser, the system comprising:
a computer processor;
a computer memory coupled for data transfer to the processor, the computer memory having disposed within it computer program instructions comprising:
a menu display module;
the menu display module capable of:
presenting a user a plurality of GUI menu fields;
receiving user speech;
selecting one of the plurality of GUI menu fields in dependence upon user speech and field selection rules; and
displaying, in a GUI display box for the plurality of GUI menu fields, menu choices for the selected GUI menu field.

8. The system of claim 7 wherein the menu display module is further capable of receiving a user speech instruction to select a particular GUI menu field.

9. The system of claim 7 wherein the display module is further capable of:
receiving a selection of a menu choice from a user;
determining whether the selection matches one of a plurality of menu choices associated with the plurality of GUI menu fields;
identifying a GUI menu field associated with the selection if the selection matches one of the menu choices; and
identifying at least one GUI menu field not associated the matching menu choice.

10. The system of claim 9 wherein the display module is further capable of prompting a user to select a menu choice of at least one of the GUI menu field not associated the matching menu choice.

11. The system of claim 7 wherein the display module is further capable of highlighting the selected GUI menu field.

12. The system of claim 7 wherein the display module is further capable of displaying to the user an icon representing a selection attribute of at least one of the plurality of GUI menu fields.

13. A computer program product for displaying available menu choices in a multimodal browser;
the computer program product disposed upon a recording medium, the computer program product comprising:
computer program instructions that present a user a plurality of GUI menu fields;
computer program instructions that receive user speech;
computer program instructions that select one of the plurality of GUI menu fields in dependence upon user speech and field selection rules; and
computer program instructions that display, in a GUI display box for the plurality of GUI menu fields, menu choices for the selected GUI menu field.

14. The computer program product of claim 13 wherein computer program instructions that receive user speech further comprise computer program instructions that receive a user instruction to select a particular GUI menu field.

15. The computer program product of claim 13 wherein computer program instructions that select the GUI menu field in dependence upon field selection rules further comprise:
computer program instructions that receive a selection of a menu choice from a user; and
computer program instructions that determine whether the selection matches one of a plurality of menu choices associated with the plurality of GUI menu fields;
computer program instructions that identify a GUI menu field associated with the selection if the selection matches one of the menu choices; and
computer program instructions that identify at least one GUI menu field not associated the matching menu choice.

16. The computer program product of claim 15 further comprising computer program instructions that prompt a user to select a menu choice of at least one of the GUI menu field not associated the matching menu choice.

17. The computer program product of claim 13 further comprising computer program instructions that highlight the selected GUI menu field.

18. The computer program product of claim 12 further comprising computer program instructions that display to the user an icon representing a selection attributes of at least one of the plurality of GUI menu fields.
